(19) United States
(12) Patent Application Publication
(10) Pub. No.: US 2006/0088724 A1
(43) Pub. Date: Apr. 27, 2006

(54) Anodization to enhance adhesion for metal composite

(75) Inventors: William Yannetti, Chesapeake, VA (US); Joseph J Rudisi, Virginia Beach, VA (US); Richard N Harford, Chesapeake, VA (US); David J Kearney, Newport News, VA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Chemical America, Inc., Chesapeake, VA (US)

(21) Appl. No.: 10/513,338

(22) PCT Filed: Nov. 25, 2003
(86) PCT No.: PCT/US03/37632

§ 371 Date: Dec. 9, 2005

Related U.S. Application Data
(60) Provisional application No. 60/428,739, filed on Nov. 25, 2002.

(51) Int. Cl. B21D 39/00; B32B 15/08

(52) U.S. Cl. 428/624; 428/626

(57) ABSTRACT

Improved adhesion characteristics in a metal-resin composite laminate are provided by the production of enhanced anodized surface characteristics with a separate one-sided etch for metal coil compositions, that can be used for coils of metal substrates that are incorporated into metal composites, particularly for use in exterior applications having enhanced durability and weather-ability, such as traffic signage and fascia display patterns.

### BACKGROUND OF THE INVENTION

1. Field of the Invention

The present invention relates to a method for providing proper increased adhesion for composite compositions useful for coating anodized metal substrates, especially bright, sealed, anodized aluminum substrates associated with coils of such metal substrates for making the composites, and the composites produced thereby.

2. Discussion of the Background

Various composite laminates are known wherein a metal sheet is laminated on a thermoplastic synthetic resin sheet. Such composites are useful for a number of architectural applications, because the composites combine light weight with high strength. These composites may be used as finished surfaces for all or some portion of the interior or exterior surfaces of a building. It as also desirable to produce metal-resin composite laminates that are used outdoors including those used for signage in construction work zone areas along streets and highways. The metal-resin composite laminates must exhibit good weathering resistance with regard to temperature and humidity changes experienced during outside exposure and be capable of bending to a sharp angle without cracking of the laminate on the exposed exterior surface of the metal or delamination of the composite. The composite must be capable of being cut to specified lengths, curved, routed, sawn, filed, drilled, punched or sheared and fastened in order to complete fabrication of the desired item. These processes can lead to irregular edges of the final composite product and in cases where good adhesion between the “bottom sides” of the aluminum sheets and the center thermoplastic portion is not achieved, there is the potential for peeling or even delamination for exterior applications, which ultimately results in product failure.

Additionally, there remains a need for coated metal sheets that may have exterior lamination and offer resistance to cracking, stress crazing, delamination, impact, and the like during fabrication and testing of the composite, especially for outdoor applications.

U.S. Pat. No. 4,560,623 discloses a specular product of bronze-like tone particularly suitable for use as a decorative material. The specular product uses, as a substrate, a composite board comprising a synthetic resin sheet and metal sheets laminated thereon, and includes a nickel deposit plated on the metal sheet and a specular film of Sn—Ni alloy electroplated on the nickel deposit using a specific electroplating bath.

U.S. Pat. No. 4,508,425 discloses a mirror-like surface manufactured by plating chromium on one surface of a metal sheet bonded to a composite sheet, made up of a synthetic resin sheet and the metal sheet, to form the mirror surface. The mirrored finish sheet may be worked to a desired shape and may be formed with a decorative pattern.

However, there remains a need for coated metal sheets with a high degree of adhesion which allow for proper bonding between the aluminum sheets and the thermoplastic center portion to improve conditions for outdoor use. There also remains a need for such laminates so that they can be bent to a sharp angle without cracking, peeling or delamination of the composite. There also remains a need for methods for preparing such metal sheets and such laminates.

A process for achieving an aluminum sheet with one side that is etched to form an improved adhesion surface is detailed in US Patent Application U.S. 2002/0040888 A1 as well as EP 1 227 174 A2 (the relevant portions of both of which are hereby incorporated by reference) and involves etching with a sodium hydroxide solution and provides a morphology that includes spike-like protrusions on an anodic layer of aluminum. The spike like protrusions making up the bonding layer are between 1 and 20 nanometers, most preferably between 5 and 6 nm in height.

The coil industries, for a number of years, have provided coated unsealed, anodized metal substrates which have been anodized by an electrochemical process employing sulfuric acid, chromic acid, phosphoric acid, or oxalic acid electrolytes. Such unsealed, anodized metal substrates provide an excellent base for adhesion of a paint, enamel or lacquer coating because of the porosity of the anodized metal surface. Clear methacrylate lacquers have been known for years to be useful to paint such unsealed, anodized metal surfaces to provide a high gloss coating. However, it is the bonding between the metal substrate surface and that of the thermoplastic resin sheet in the center that has been an ongoing problem with regard to outdoor use. It is generally understood and accepted that composites for outdoor construction must be more durable and resilient based upon more severe climatic changes.

It has also been known to seal such anodized metal substrates where it is desired to employ the metal in an environment where the porosity of the anodized metal is undesirable, such as for example when used in auto trim parts where exposure to the elements can result in corrosion or staining of the metal. Sealing of such anodized metal substrates, such as by immersion in boiling deoinized water, sodium bichromate, nickel acetate solutions or steam, makes the anodized coating on the metal nonabsorptive by closing down or plugging the pore structure of the anodized coating. Additionally, sealing of the anodized metal substrate can substantially reduce the abrasion resistance thereof. When anodized metal substrates have been sealed, it is very difficult for paint or a coating to adhere to the surface of the sealed, anodized metal substrate.

### SUMMARY OF THE INVENTION

Accordingly, one object of the present invention is to provide a composite laminate which has improved adhesion between the outer metal plates of the composite and the thermoplastic layer between the metal plates.

A further object of the present invention is to provide a method for providing improved adhesion between metal plates and thermoplastic resin layers in a metal/thermoplastic composite laminate.

A further object of the present invention is to provide a composite laminate with improved performance for outdoor use.

These and other objects of the present invention have been satisfied, either individually or in combinations of the stated objects, by the discovery of a metal-resin composite laminate metal sheet comprising:
(a) a resin sheet; and
(b) a pair of coated metal sheets, each of said pair of coated metal sheets having an interior and an exterior surface, said interior surfaces facing and bonded to said resin sheet;
wherein each of said interior surfaces have been anodized and etched to provide either (a) a root mean square surface roughness comprising peak heights of at least 200 nanometers or (b) a Rmax (maximum peak height−maximum valley depth) of at least 700 nanometers; and a metal oxide thickness of greater than 0.5 microns.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein;

FIG. 1. An AFM image of the surface facing away from the thermoplastic sheet of the composite.

FIG. 2. An AFM image of the aluminum surface facing toward the thermoplastic sheet for adhesion with that surface.

FIG. 3. Provides a cross-sectional view of the coated metal sheet of the present invention;

FIG. 4 provides a cross-sectional view of the metal-resin composite laminate of the present invention;

FIG. 5 illustrates an apparatus for forming the coated metal plates of the present invention; and

FIG. 6 illustrates an apparatus for forming composite laminates containing a coated metal plate according to the present invention.

### DETAILED DESCRIPTION OF THE INVENTION

The present invention relates to the achievement of enhanced anodized surface characteristics with a separate one-sided etch for metal coil compositions by improving adhesion, such that the process can be used for coils of metal substrates used for metal composite applications. The results described herein are primarily used in a most preferred embodiment to enhance the durability and weather-ability of an aluminum composite for any purposes, especially for outdoor applications, including traffic signage and fascia display patterns.

The present invention relates to an anodized and etched metal, preferably aluminum, sheet with spike protrusions that are greater than 200 nanometers in height. The present invention further relates to composites whereby the portion of the inorganic metal, preferably aluminum, sheet facing the thermoplastic center is specially prepared to promote the highest level of adhesion possible with the organic thermoplastic center portion of the composite to sufficiently permit post-coating forming, molding, bending or shaping of the metal into suitable parts, especially for use as components of composite building or construction panels, without delaminating or otherwise being damaged. The invention also relates to a process for coating coils of such metal substrates to obtain the aforementioned properties as well as providing a metal substrate in which the coated coil can be used for interior or exterior decorative purposes. The invention also relates to the coated metal plates prepared by such processes and laminates comprising such coated metal plates.

Thus, in a first embodiment, the present invention relates to a metal composite comprising
(a) A pair of two sided metal substrates in the form of a coil, web or sheet;
(b) A thermoplastic sheet comprising a center portion between the two metal substrates
(c) where each of the two-sided metal substrates have surfaces that have been specially prepared by anodization and a single side that has been etched to ensure enhanced adhesion.

The metal plate may be formed of any of various metals such as aluminum, iron, copper, tin, steel, and the like. Aluminum and iron are preferred, and aluminum is particularly preferred. Although there is no particular constraint on the thickness of the metal plate, if the coated metal plate is to be used as a component in a composite laminate, it is preferred that the plate have a thickness of 0.01 to 2 mm, most preferably 0.1 to 0.8 mm.

The present invention provides a solution to long felt needs in the industry that includes providing a surface along only one side, the “underside” portion adjacent the thermoplastic core of the composite, of the metal sheet that promotes adhesion levels which allow for outdoor use.

A subsequent etch of the metal substrate will cause the surface to become roughened, thereby allowing for increased adhesion. The oxide film thickness caused during the anodizing process will have a great effect on the size and type of nanometer sized protrusions or projections that occur on the finished surface. These protrusions act as tiny “hooks” that improve the adhesion characteristics of the metal surface. These protrusions are responsible for increased surface energy and represent a higher surface area to volume ratio, which are all responsible for the improved adhesion characteristics. Ensuring proper bonding between an inorganic (metal) substrate and that of an organic (thermoplastic) sheet is difficult. Silane bonding agents have been used to enhance the chemical bonding and etching metal surfaces to increase roughness has also been used in the past. Unique anodizing/etching processes such as those used to accomplish the necessary bonding forces for these surfaces are primarily based on mechanical bonding achieved with physical bonding. The use of silane agents to further promote bond strength should also be considered part of this invention.

While there is no need for an adhesive between the polymer resin sheet and the etched/anodized metal sheet, in a preferred embodiment, the metal sheet, in particular aluminum sheet, is primed on one or more surfaces. If the metal sheet is to be used in a laminate with a resin core such as a polyolefin, then the surface of the metal sheet to be bonded to the resin core is preferably primed with an epoxy coating. A silane bonding agent may also be used for priming. In a further preferred embodiment, the silane bonding agent is used as a bonding agent between the primer and the aluminum sheet. Suitable silane bonding agents are well known in the art.

The thermoplastic resin core may be composed of any resin suitable for use in metal resin laminate plates. Such resins are described in U.S. Pat. No. 4,994,130, which is incorporated herein by reference. It includes, for example, polyethylene, polypropylene, polybutane, polyvinyl chloride, polystyrene, polyamide, polyethylene terephthalate, polybutylene terephthalate and polycarbonate. From the viewpoint of the extrusion molding properties, it is preferred to employ a polyolefin synthetic resin such as polyethylene, polypropylene, or polybutene. As such a thermoplastic resin, not only a virgin material, but also a recovered material or reproduced material may be used in the form of a sheet, either by itself or mixed with virgin material. To such a thermoplastic resin, a foaming agent, a flame retardant, a filler, a coloring agent, etc. may be incorporated as the case requires. Good results have been achieved by using a low density polyethylene core.

It is particularly preferred that the metal sheet(s) be laminated with the resin core by means of an adhesive laminating film, disposed between the resin core and the metal sheet. Most preferably, the adhesive film is a modified polyolefin resin such as those described in U.S. Pat. No. 4,762,882, which is incorporated herein by reference.

Suitably, the resin core is 1 to 10 mm thick, preferably 2 to 5 mm thick. The adhesive film is suitably 10 to 100 μm thick, preferably 15 to 50 μm thick.

A laminate of the present invention may be prepared by extruding the resin core through a die to form a flat sheet and passing the extruded resin sheet through laminating rollers simultaneously with two metal sheets, one on each surface of the resin sheet. At least one and sometimes both of the metal sheets are coated according to the present invention. Further, the sheets may have a layer of fluorinated ethylene vinyl ether polymer as a coating, as described in U.S. Pat. No. 6,365,276, the contents of which are hereby incorporated by reference. The metal sheets according to the present invention are oriented such that the FEVE layers face away from the resin core.

Typically, the resin core is laminated at a temperature of 110° to 190° F., preferably 125° to 165° F. It is preferred to extrude the resin sheet to a thickness which is larger than the gap between the laminating rollers by about 10%. Preferably, the coated metal sheet is preheated to a temperature of 320° to 420° F., most preferably 330° to 400° F. before passing through the laminating rollers with the resin core. The lamination is suitably carried out at a temperature of 320° to 410° F. Suitably, the laminating pressure is 250 to 1100 psi, preferably 400 to 1000 psi.

In a preferred embodiment, the coated metal plate is laminated to the resin core by an adhesive film. In this case, a multilayered arrangement, in which the adhesive film is disposed between the metal sheet and the resin core, is forced through the laminating rollers.

In another preferred embodiment, the cured FEVE surface of the final laminate is covered with a protective film to prevent marring of the surface during stacking and shipping. Suitably, the protective film is any lightly adhesive film which will sufficiently protect the surface of the laminate and can be easily removed. Good results have been achieved with QUALITY COTE® produced by Main Tape of Union, N.J.

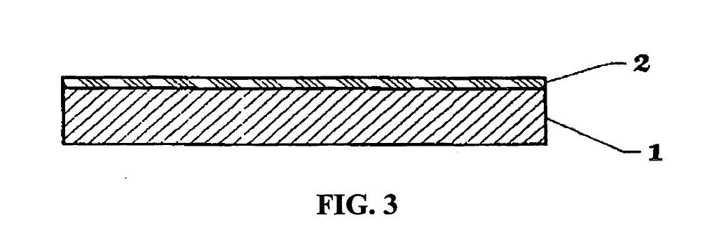

FIG. 3 shows a cross-sectional view of a preferred embodiment of coated metal sheet of the present invention. The coated metal sheet comprises a metal substrate (1) and a cured layer of FEVE paint (2).

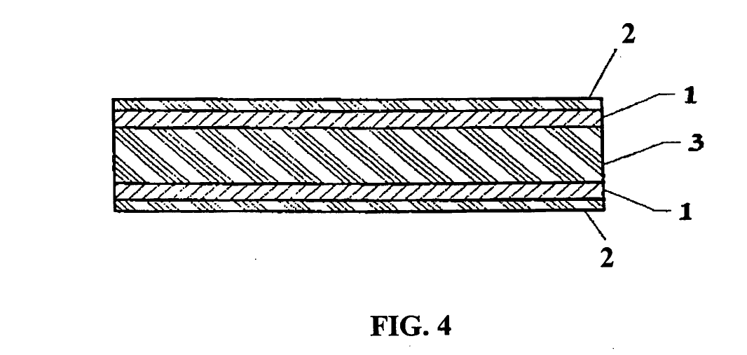

FIG. 4 shows a cross-sectional view of a metal-resin composite laminate of the present invention. Therein core (3) is sandwiched between two coated metal sheets according to the present invention each of which comprise a metal substrate (1) and a cured layer of FEVE paint (2).

The coated metal sheets are oriented such that the cured layers (2) face away from the resin core (3). Although the embodiment shown has two coated metal sheets of the present invention, it is to be understood that other embodiments will employ only one of the present coated metal sheets.

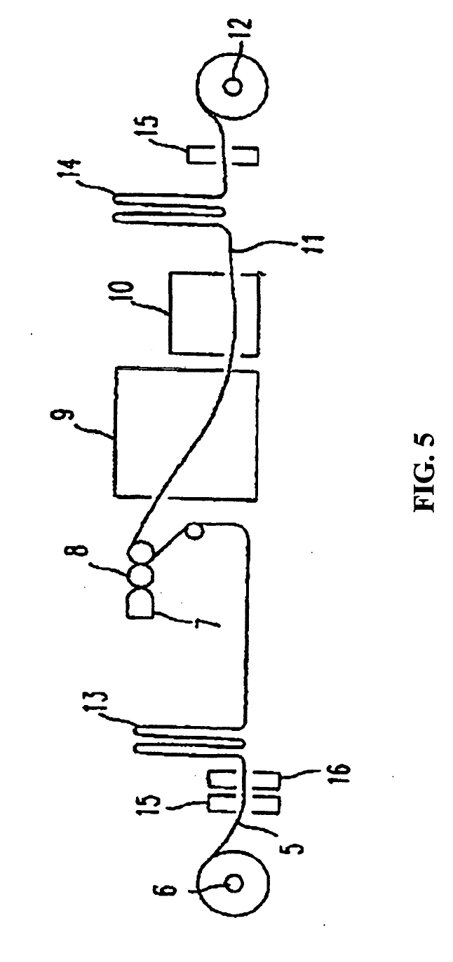

FIG. 5 schematically illustrates an apparatus used for forming the coated metal sheet of the present invention. The structure and operation of the apparatus will be discussed in terms of the formation of the embodiment containing a cured FEVE paint layer. The metal sheet (5) is uncoiled from a feed roll by means of an uncoiler (6) and the paint is optionally applied by means of die-roll coating using a die (7) and roller (8). The FEVE paint is cured by baking in an oven (9) and cooled in a cooler (10). The cured and cooled coated (11) sheet is taken up on a product roll by means of a recoiler (12). The apparatus is equipped with an entrance accumulator (13) and an exit accumulator (14) as well as entrance and exit shears (15) and an entrance joiner (16) to facilitate removal and replacement of empty feed rolls and full product rolls.

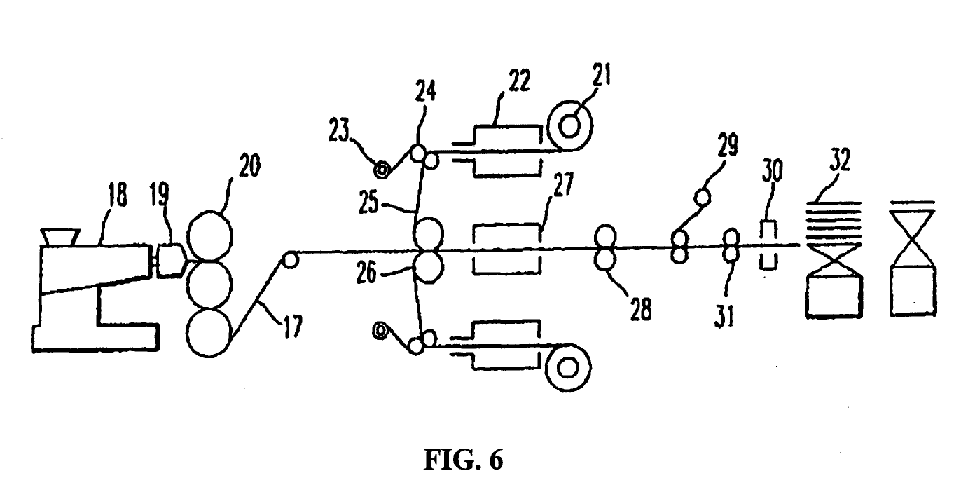

FIG. 6 schematically illustrates an apparatus used for preparing the present metal-resin composite laminates. The structure and operation of the apparatus will be discussed in terms of forming a laminate in which the resin core is sandwiched between two coated metal sheets of the present invention. However, it is to be understood that either one of the present coated metal sheets may be omitted or replaced with any suitable replacement such as an uncoated metal sheet. The resin core (17) is extruded through an extruder (18) through a T-die (19) and passed through a sheeting three roll set (20). The coated metal sheet is uncoiled from an uncoiler (20) and preheated in a preheater (22). The adhesive film (23) and the preheated coated metal sheet are passed through prelaminating rollers (24) to give a metal sheet-adhesive film composite (25) and the extruded resin core (17) that are then passed through the laminating rolls (26) and on through the cooler (27), by means of pulling rollers (28). An optional, protective film (29) may be applied downstream of the pulling rollers (28).

The shears (29) downstream of the pulling rollers (28) are for cutting the laminate to desired length and are preferably flying shears. The laminate may be cut to width by means of the slitter (or trimmer) (30). The finished product is collected on a piler (32). As noted above, the coated metal sheets and metal-resin composite laminates of the present invention possess a number of desirable characteristics. The present metal sheets and laminates may be bent to angles as sharp as 90° without cracking the coatings. The metal sheets may be bent as is, and the laminates may be bent after scoring or cutting the metal sheet along the line of bending on the acute side of the bend.

The anodization of the metal substrates of the present invention can be performed using any conventional anodization process for the particular metal used. The etching process can be any conventional etching capable of creating the desired root mean square surface roughness or Rmax (difference between maximum peak and maximum valley). The etchant can be acidic or basic depending on the metal substrate used. Preferred etchants in the case of a preferred aluminum substrate, include, but are not limited to, sodium hydroxide, calcium hydroxide, phosphoric acid, hydrofluoric acid, sulfuric acid, bromic acid and chromic acid. In the present invention, the particular anodization and etching process used is not particularly important. A preferred anodization and etching process includes a process similar to that of US Published Application 2002/0040888, incorporated herein by reference. One example of a process that can be used is the ADHERE process, commercially available from Lorin Industries (Muskegon, Mich.).

The important factor is that the process be performed to provide the desired Rq and Rmax. The process of the present invention is performed for a time period and under conditions suitable to provide the required root mean square surface roughness comprising peak heights of at least 200 nanometers, preferably at least 250 nanometers, more preferably from 250 to 325 nanometers, and a metal oxide thickness of greater than 0.5 microns, preferably greater than 0.7 microns, more preferably from 0.7 to 1.8 microns. In an additional embodiment, the factor to be controlled is the difference between the maximum peak height and maximum valley depth (Rmax) in the finally anodized and etched product. The Rmax is preferably at least 700 nanometers, more preferably at least 750 nanometers, still more preferably at least 1000 nanometers, most preferably from 1000 to 1500 nanometers. In a most preferred embodiment, the anodization and etching process is performed to give a combination of Rq and Rmax of Rq from 250 to 325 nanometers and Rmax of from 1000 to 1500 nanometers.

One of ordinary skill in the art would readily understand what is required to modify the process of U.S. 2002/0040888 to achieve such peak heights, such as, for example, increasing the etching time per unit area, changing etchant type, changing etching temperature, etc.

Such coated coil substrates are also characterized by excellent adhesion characteristics such that the coated metal coil substrates can be formed into desired parts of elements without delamination or cracking of the coated metal substrates. In fact, coated coil substrates of the present invention have been subjected to a 21 day fresh water/room temperature without showing evidence of delamination of the thermoplastic sheet from the anodized and etched aluminum surfaces and while maintaining adhesion strength between the anodized and etched aluminum surfaces at a significantly level than aluminum surfaces that have not been subjected to the combination of anodization and etching as required in the present invention.

### EXAMPLES

Analysis of an aluminum surface that has been anodized on one side and anodized and etched on the other side gave the following: Test results showed the improved performance of using the metal composite with the anodized and subsequent one-sided etch of the present invention. It is clear from the test results, that the anodized and one-sided etch surface is most preferred in order to pass the stringent 21 day water immersion test as indicated by the resulting peel strengths.

### Atomic Force Microscopy (AFM) Evaluation of Coated Aluminum

An aluminum sheet, which was coated on front surface, was evaluated by AFM (atomic force microscopy) to quantify its surface roughness and compare it with its back surface.

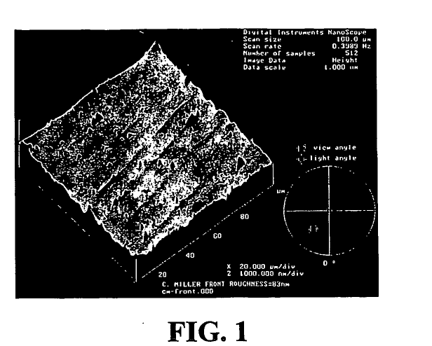

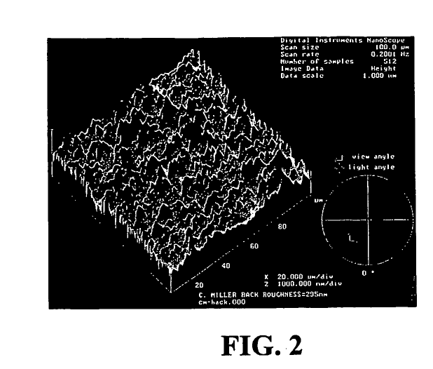

Two measurements were made on the front and back surface. AFM uses a very sharp point stylus to measure surface contour. Simply stated, the stylus was driven at a high frequency at proximity to the surface, any height variation on the surface altering the frequency of the stylus, and this signal was converted to a voltage, which was manipulated and used to determine height. The scan was then repeated across the surface at a slightly different “y” position and the data collected. The composite of 512 scans along the “y” direction produced the surface image. FIGS. 1 and 2 show the AFM images obtained of the front and back of the sample. The scan selected was for an area of 100 um×100 um. Clearly the two faces were different and the surface of FIG. 1 (exterior or front side) was much smoother than the surface of FIG. 2 (interior or back side).

To evaluate and quantify the surface roughness, the following procedure was used. First the mean of all heights were obtained, then the root mean square of all points was obtained using the following formula:
Rq={(Σ(zᵢ−zₘₑₐₙ)²/N)}^{1/2}

Where Zi is the height at each point, and N is the total number of data points.

This procedure produced a roughness value of 83 nm for FIG. 1 and 295 nm for FIG. 2.

To understand the superior performance of the present process, in fresh water immersion, when compared to a standard thin anodized back surface, four surfaces were tested:
1) The present process “modified” surface (a thin anodized and etched surface using the ADHERE process from Lorin Industries). This surface has passed all fresh water immersion testing.
2) The standard thin anodized surface, which showed some failures in the fresh water immersion testing, while some lots passed.
3) The back surface of an aluminum coil anodizing product “ACA” (in which the back side was etched with phosphoric acid to give a rougher macro-surface than the use of sulfuric acid) test samples. These samples passed the fresh water immersion testing.
4) The backside of a PM41 sample from Lorin, having a backside etched with sulfuric acid and a highly polished aluminum substrate. Samples of this surface have been run with good results in fresh water immersion.

Atomic Force Microscopy (AFM) was selected to measure the surface properties of the samples. The surface roughness measure Rq is calculated by the following equation:
Rq={(Σ(zᵢ−zₘₑₐₙ)²/N)}^{1/2}

Rmax=Maximum peak to maximum valley delta

| | Rq Result (nm) | Rmax |
|---|---|---|
| Present invention anodize/etch | 295 | 1,400 |
| Standard thin anodized | 83 | 445 |
| ACA back side | 136 | 750 |
| PM41 Non-adhere back side | 75 | 680 |

The analysis of the Rq value of the present invention back and the thin anodized face appeared to explain the significant difference in the fresh water performance of the laminates. The present invention back, with an Rq of 295 allowed for more mechanical bonding when compared to the thin anodized face with an Rq of 83.

Based on the successful fresh water immersion test performance of the ACA sample and the P41 high polished from Lorin we sent those samples for analysis. The ACA sample Rq was measured at 136 and seemed to fit the hypothesis. However the P41 back surface Rq measured 75, lower than the thin anodized surface, which has given failures in fresh water immersion.

It was noted that there appeared to be higher peaks and lower valleys on the P41 sample when compared to the thin anodized face. The Rq parameter, which is an expression of the summation of the relative difference between the mean height and the measured heights, while providing some level of prediction of fresh water immersion test performance, did not appear to be the best predictor of good performance in the fresh water immersion test. The R max values, which is a measure of the maximum peak height to the maximum valley depth was measured and appears to better predict immersion test performance.

The present application is based on U.S. Provisional Application 60/428,739, filed in the U.S. Patent Office on Nov. 25, 2002, the entire contents of which are hereby incorporated by reference.

With the foregoing description of the invention, those skilled in the art will appreciate that modifications may be made to the invention without departing from the spirit thereof. Therefore, it is not intended that the scope of the invention be limited to the specific embodiments illustrated and described.

1. A metal-resin composite laminate metal sheet comprising:
(c) a resin sheet; and
(d) a pair of coated metal sheets, each of said pair of coated metal sheets having an interior and an exterior surface, said interior surfaces facing and bonded to said resin sheet;
wherein each of said interior surfaces have been anodized and etched to provide a root mean square surface roughness comprising peak heights of at least 200 nanometers and a metal oxide thickness of greater than 0.5 microns.

2. The laminate of claim 1, wherein the root mean square surface roughness comprises peak heights of at least 250 nanometers.

3. The laminate of claim 2, wherein the root mean square surface roughness comprises peak heights of at from 250 to 325 nanometers.

4. The laminate of claim 1, wherein said metal substrate is selected from the group consisting of aluminum, iron, copper, tin, and steel.

5. The laminate of claim 4, wherein said metal substrate is aluminum.

6. The laminate of claim 1, wherein said metal substrate has a thickness of 0.01 to 2 mm.

7. The laminate of claim 1, wherein said resin sheet has a thickness of 1 to 10 mm.

8. The laminate of claim 1, wherein said resin sheet comprises a resin selected from the group consisting of polyethylene, polypropylene, polybutene, polyvinyl chloride, polystyrene, polyamide, polyethylene terephthalate, polybutylene terephthalate, and polycarbonate.

9. The laminate of claim 8, wherein said resin sheet comprises polyethylene.

10. The laminate of claim 1, wherein said resin sheet further comprises 0.05% to 0.4% of carbon black, based on the total weight of said resin sheet.

11. A metal-resin composite laminate metal sheet comprising:
a resin sheet; and
a pair of coated metal sheets, each of said pair of coated metal sheets having
an interior and an exterior surface,
said interior surfaces facing and bonded to said resin sheet;
wherein said interior surfaces have been anodized and etched to provide a root mean square surface roughness comprising peak heights of at least 200 nanometers and a metal oxide thickness of greater than 0.5 microns and;
wherein said interior surfaces are further treated with a silane bonding agent prior to bonding with resin sheet.

12. The laminate of claim 11, wherein the root mean square surface roughness comprises peak heights of at least 250 nanometers.

13. The laminate of claim 12, wherein the root mean square surface roughness comprises peak heights of from 250 to 325 nanometers.

14. The laminate of claim 11, wherein said metal substrate is selected from the group consisting of aluminum, iron, copper, tin, and steel.

15. The laminate of claim 14, wherein said metal substrate is aluminum.

16. The laminate of claim 11, wherein said metal substrate has a thickness of 0.01 to 2 mm.

17. The laminate of claim 11, wherein said resin sheet has a thickness of 1 to 10 mm.

18. The laminate of claim 11, wherein said resin sheet comprises a resin selected from the group consisting of polyethylene, polypropylene, polybutene, polyvinyl chloride, polystyrene, polyamide, polyethylene terephthalate, polybutylene terephthalate, and polycarbonate.

19. The laminate of claim 18, wherein said resin sheet comprises polyethylene.

20. The laminate of claim 11, wherein said resin sheet further comprises 0.05% to 0.4% of carbon black, based on the total weight of said resin sheet.

21. A metal-resin composite laminate metal sheet comprising:
(e) a resin sheet; and
(f) a pair of coated metal sheets, each of said pair of coated metal sheets having an interior and an exterior surface, said interior surfaces facing and bonded to said resin sheet;
wherein each of said interior surfaces have been anodized and etched to provide a Rmax (maximum peak height−maximum valley depth) of at least 700 nanometers and a metal oxide thickness of greater than 0.5 microns.

22. The laminate of claim 21, wherein the Rmax is at least 750 nanometers.

23. The laminate of claim 22, wherein the Rmax is at least 1000 nanometers.

24. The laminate of claim 23, wherein the Rmax is from 1000 to 1500 nanometers.

25. The laminate of claim 21, wherein said metal substrate is selected from the group consisting of aluminum, iron, copper, tin, and steel.

26. The laminate of claim 25, wherein said metal substrate is aluminum.

27. The laminate of claim 21, wherein said metal substrate has a thickness of 0.01 to 2 mm.

28. The laminate of claim 21, wherein said resin sheet has a thickness of 1 to 10 mm.

29. The laminate of claim 21, wherein said resin sheet comprises a resin selected from the group consisting of polyethylene, polypropylene, polybutene, polyvinyl chloride, polystyrene, polyamide, polyethylene terephthalate, polybutylene terephthalate, and polycarbonate.

30. The laminate of claim 29, wherein said resin sheet comprises polyethylene.

31. The laminate of claim 21, wherein said resin sheet further comprises 0.05% to 0.4% of carbon black, based on the total weight of said resin sheet.

32. A metal-resin composite laminate metal sheet comprising:
a resin sheet; and
a pair of coated metal sheets, each of said pair of coated metal sheets having
an interior and an exterior surface,
said interior surfaces facing and bonded to said resin sheet;
wherein said interior surfaces have been anodized and etched to provide a Rmax (maximum peak height−maximum valley depth) of at least 700 nanometers and a metal oxide thickness of greater than 0.5 microns and;
wherein said interior surfaces are further treated with a silane bonding agent prior to bonding with resin sheet.

33. The laminate of claim 32, wherein the Rmax is at least 750 nanometers.

34. The laminate of claim 33, wherein the Rmax is at least 1000 nanometers.

35. The laminate of claim 34, wherein the Rmax is from 1000 to 1500 nanometers.

36. The laminate of claim 32, wherein said metal substrate is selected from the group consisting of aluminum, iron, copper, tin, and steel.

37. The laminate of claim 36, wherein said metal substrate is aluminum.

38. The laminate of claim 32, wherein said metal substrate has a thickness of 0.01 to 2 mm.

39. The laminate of claim 32, wherein said resin sheet has a thickness of 1 to 10 mm.

40. The laminate of claim 32, wherein said resin sheet comprises a resin selected from the group consisting of polyethylene, polypropylene, polybutene, polyvinyl chloride, polystyrene, polyamide, polyethylene terephthalate, polybutylene terephthalate, and polycarbonate.

41. The laminate of claim 40, wherein said resin sheet comprises polyethylene.

42. The laminate of claim 32, wherein said resin sheet further comprises 0.05% to 0.4% of carbon black, based on the total weight of said resin sheet.

43. The laminate of claim 21, wherein said interior surface further has a root mean square surface roughness of at least 200 nanometers.

44. The laminate of claim 32, wherein said interior surface further has a root mean square surface roughness of at least 200 nanometers.
